(19) United States
(12) Patent Application Publication
(10) Pub. No.: US 2006/0178031 A1
(43) Pub. Date: Aug. 10, 2006

(54) Central processor unit connector

(76) Inventor: Kuang-Chih Lai, Tucheng City (TW)

Correspondence Address: HDSL, 4331 STEVENS BATTLE LANE, FAIRFAX, VA, 22033, US

(21) Appl. No.: 11/271,907

(22) Filed: Nov. 14, 2005

(30) Foreign Application Priority Data
Feb. 5, 2005 (TW) 094103989

(51) Int. Cl. H01R 13/62

(52) U.S. Cl. 439/331

(57) ABSTRACT

A CPU connector includes at least one terminal and the terminal includes a first spring section moved along a bevel of a latitude rib of a protection board in order to preload the terminal in a through hole of the protection board. The first spring section pushes upward the bevel of the protection board such that the terminal has uniform action of CPU contact face. The terminal includes arc section to scratch dirt on CPU contact face. When the terminal is soldered to contact of the motherboard, the terminal release pressure to push downward the tin ball. The terminal can be soldered to motherboard without needing high evenness. The terminal board can be directly clamped into a frame and a handle on a cover can be rotated to clamp the terminal board.

### BACKGROUND OF THE INVENTION

1. Field of the Invention

The present invention relates to a central processor unit (CPU) connector, especially to a CPU connector having terminal with arc section, and the improvement over protection board, and frame.

2. Description of Related Art

The conventional CPU connector generally comprises a terminal plate with terminals on one side thereof and the terminal has solder ball at distal end thereof. The solder ball can be fixed to the distal end of the terminal by reflow process. Afterward the terminal plate is placed in a metal frame and fixed to the metal frame by ultra sonic fusion. The terminal plate is then soldered to a motherboard and then a CPU is assembled atop the terminal plate. An operation arm is used to press the CPU for connecting the CPU with the motherboard. However, the contact end of the terminal is exposed out of the terminal plate and is liable to deform, thus resulting poor contact or open circuit.

### SUMMARY OF THE INVENTION

According to one aspect of the present invention, the present invention provides a CPU connector including at least one terminal and the terminal including a first spring section moved along a bevel of a latitude rib of a protection board in order to preload the terminal in a through hole of the protection board. The first spring section pushes upward the bevel of the protection board such that the terminal has uniform action of CPU contact face. The terminal includes arc section to scratch dirt on CPU contact face.

According to another aspect of the present invention, the present invention provides a CPU connector wherein the contact on the motherboard is applied with tin paste and the connector passes reflow oven. The tin ball will molten by heat and pushed downward by released pressure of terminal. The terminal can be soldered to motherboard without needing high evenness.

According to still another aspect of the present invention, the terminal board can be locked into the frame without needing ultrasonic fusion,

According to still another aspect of the present invention, the handle of the cover in the frame of the CPU connector can be correctly clamped.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIGS. 1A and 1B show the terminal of the CPU connector according to a preferred embodiment of the present invention.

FIG. 1C shows a sectional view of the terminal clamping solder ball in the CPU connector of the present invention.

FIG. 2 shows the terminal clamping solder ball in the CPU connector of the first preferred embodiment of the present invention.

FIG. 3 shows the terminal clamping solder ball in the CPU connector of the second preferred embodiment of the present invention.

FIG. 4 shows the terminal clamping solder ball in the CPU connector of the third preferred embodiment of the present invention.

FIG. 5 shows an exploded view of the terminal board and frame in the CPU connector of the present invention.

FIG. 6 shows a perspective view of the terminal board and frame in the CPU connector of the present invention.

FIG. 7 shows a perspective view of the frame of the CPU connector according to the present invention.

### DETAILED DESCRIPTION OF THE INVENTION

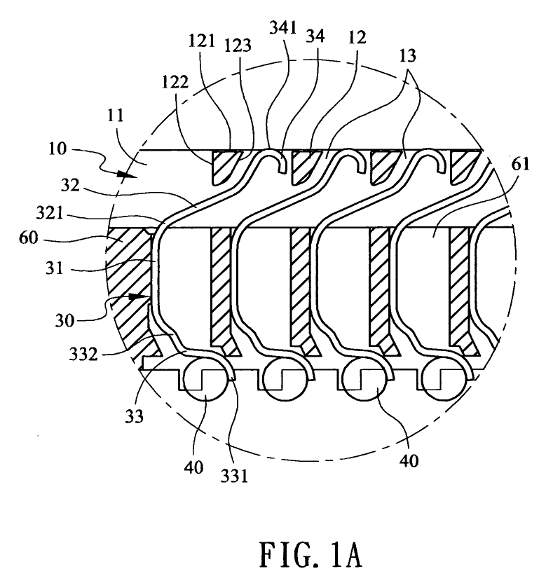

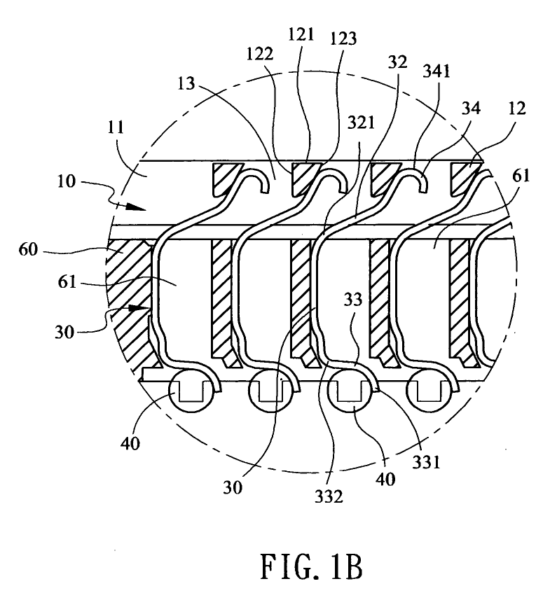

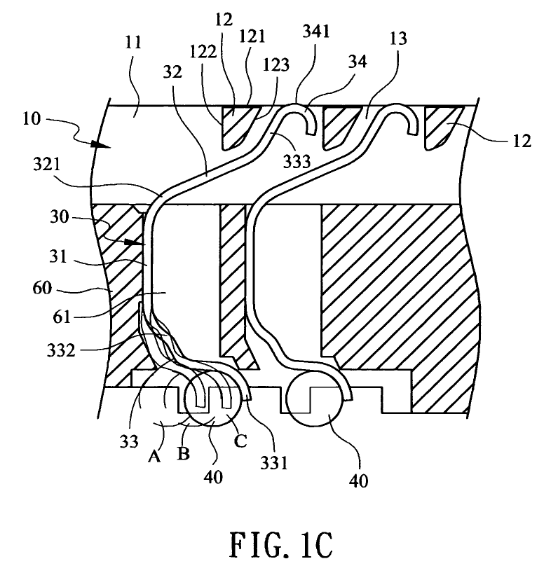

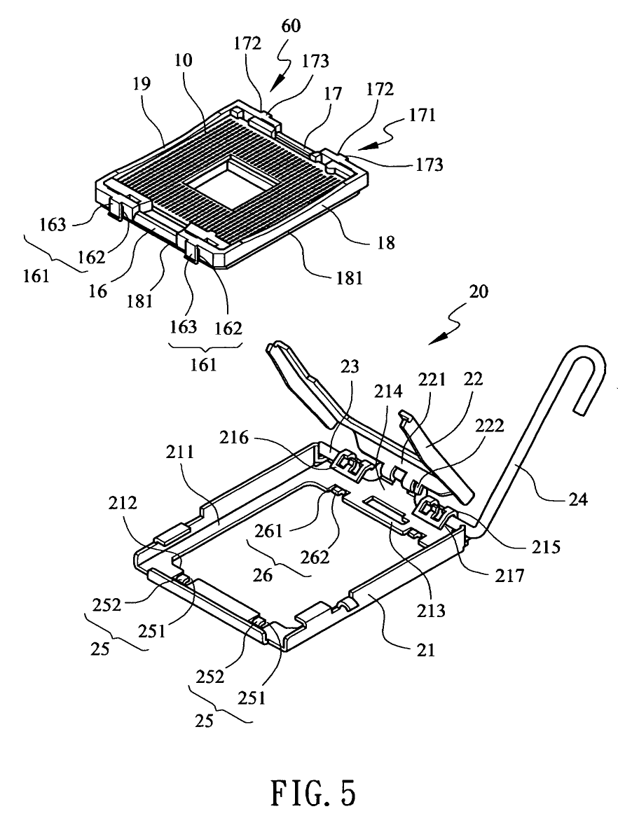

FIGS. 1A and 1B show the terminal of the CPU connector according to a preferred embodiment of the present invention. The CPU connector according to the preferred embodiment of the present invention mainly comprises a protection board 10, a frame 20 and a terminal board 60 as shown in FIG. 5. The protection board 10 can be assemble into the terminal board 60 and used to protect a first spring portion 32 of exposed terminal 30. The terminal board 60 assembled with the protection board 10 is assembled into the frame 20. The protection board 10 is a rectangular plate and comprises a plurality of longitudinal ribs 11 and a plurality of latitude ribs 12 such that a through hole 13 is defined between the longitudinal ribs 11 and the latitude ribs 12. The terminal board 60 comprises a plurality of terminal holes 61 and each of the terminal holes 61 contains a terminal 30 therein.

The longitudinal ribs 11 are vertical to the latitude ribs 12 and the latitude rib 12 comprises a first face 121, a second face 122 and a bevel 123 with the first face 121 parallel to the longitudinal ribs 11. The terminal 30 comprises an attaching section 31, a first spring section 32, and a second spring section 33. The attaching section 31 comprises a first spring section 32 and a second spring section 33 on both ends thereof. The first spring section 32 comprises an arc section 34 at free end thereof and the arc section 34 comprises a curve part 341. Therefore, the dirt on the contact face of the CPU can be scratched when the terminal 30 is moved across the CPU. When the CPU is pressed down in opening state, the bevel 123 can push the first spring section 32 to generate a preload pressure for the first spring section 32 in contact with the CPU. Therefore, the first spring section 32 has larger friction force to remove dirt on surface of CPU. The first spring section 32 is guided by the bevel 123 to reach a predetermined position of the CPU. When the CPU is in opening state, the first spring section 32 acts on the bevel 123 such that the first spring section 32 pushes the bevel 123 of the rib 12 upward and the terminal 30 is received into the protection board 10. The spring section 32 further comprises S shaped arced section 321 connected with the attaching section 31 to increase spring swing thereof. When the terminal 10 pushes the bevel 123 of the rib 12, the terminal 30 is moved along contact face of the CPU to scratch dirt therefrom. The first spring section 32 comprises a slanting line segment 333 to push the bevel 123 of the rib 12.

FIG. 1C shows a sectional view of the terminal clamping solder ball in the CPU connector of the present invention. The second spring section 33 comprises a continuous curve section 332 connected to the attaching section 31 and the second spring section 33 comprises a protecting section 331 at free end thereof to hold a solder ball 40 together with the bottom structure of the terminal board 60. The solder ball 40 enters the protecting section 331 of the terminal 30 from the position A. At this time, the second spring section 33 does not provide pushing force for the solder ball 40 and the front end of the protecting section 331 of the terminal 30 can guide the solder ball 40 to enter the protecting section 331. When the solder ball 40 is moved to the position B, the protecting section 331 of the terminal 30 is moved apparently. When the solder ball 40 is moved to the position C, the protecting section 331 and the bottom structure of the terminal board 60 together hold a solder ball 40. The protecting section 331 provides a pressure to the solder ball 40 when the solder ball 40 is moved from position A to position B and then to position C. During usage, the contact of the motherboard is applied with tin paste and the connector is placed at corresponding place and passes a reflow oven. The solder ball 40 is molten due to heat and the terminal 40 releases pressure to push downward the solder ball 40. Therefore, the unevenness of the motherboard can be compensated and the soldering yield can be enhanced.

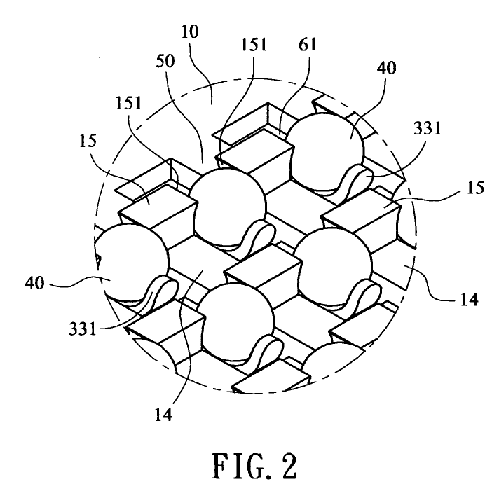

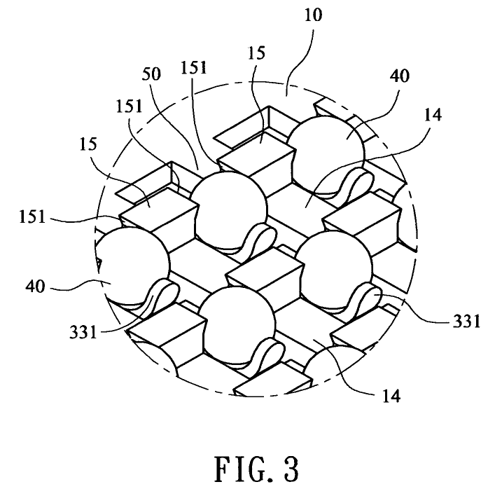

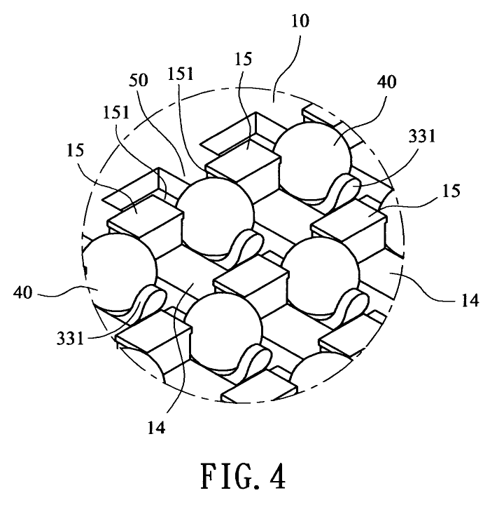

FIGS. 2, 3, and 4 shows the terminal clamping solder ball in the CPU connector of the first, the second and the third preferred embodiment of the present invention. The terminal board 60 comprises a plurality of first ribs 14 and a plurality of second ribs 15 on bottom thereof. Preferably the second rib 15 is placed atop the first ribs 14. A plurality of passageways 50 is defined between the second rib 15 and a terminal hole 61 is defined between the first rib 14 and the second rib 15 and containing a terminal 30 therein. The second rib 15 comprises a clamping face 151 facing the passageway 50 and the protecting section 331 of the terminal 30 clamps the tin ball 40 together with the clamping face 151, thus fixing the tin ball 40. As shown in FIG. 2, the clamping face 151 can be arc face such that the clamping points on both ends of the second rib 15 and the protecting section 331 of the terminal 30 provide three clamping points for clamping the tin ball 40. As shown in FIG. 3 the clamping face 151 can be bevel face. As shown in FIG. 3 the clamping face 151 can be stair face.

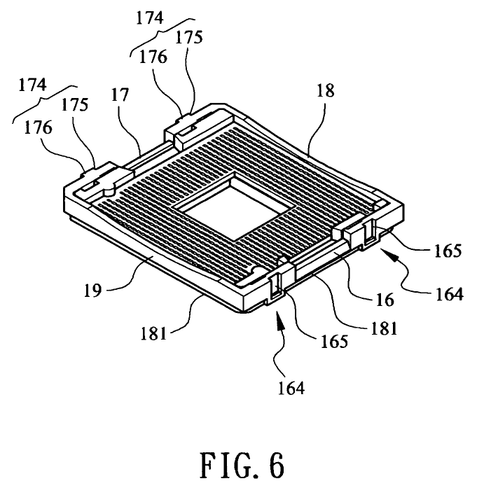

FIGS. 5 and 6 shows the terminal board and frame in the CPU connector of the present invention. The CPU connector of the present invention comprises a frame 20 and a terminal board 60. The terminal board 60 comprises a first end face 16 and a second end face 17. The first end 16 comprises a plurality of first lockers 161 and the second end face 17 comprises a plurality of second lockers 171. The frame 20 comprises a rack 21 and a cover 22 pivotally connected by a crank 23 to have relative rotation therebetween. The rack 21 comprises a stair 211 with a first edge 212 and a second edge 213. The first edge 212 comprises a plurality of third lockers 25 and the second edge 213 comprises a plurality of fourth lockers 26 corresponding to the third lockers 25. Therefore, the first lockers 161 are engaged with the third lockers 25 and the second lockers 171 are engaged with the fourth lockers 26.

As shown in FIG. 5, the first locker 161 is a first dent 162 and a spring tenon 163 vertically provided at top of the first dent 162. The second locker 171 is a second dent 172 and a spring tenon 173 is vertically provided at top of the second dent 172. Therefore, the first locker 161 and the second locker 171 have the same structure. The third locker 25 is a first recess 251 and a first bump 252 is provided in the first recess 251. The fourth locker 26 is a second recess 261 and a second bump 262 is provided in the second recess 261. Therefore, the spring tenon 163 of the first dent 162 can be engaged with the first bump 252; while the spring tenon 173 of the second dent 172 can be engaged with the second bump 262.

FIG. 6 shows the locker according to another preferred embodiment of the present invention. The first locker 164 is a first dent 165 and the second locker is a second dent 175. A spring tenon 176 is extended downward vertically from top of the second dent 175. The third locker 25 is a first recess 251 and a first bump 252 is provided in the first recess 251, the fourth locker 26 is a second recess 261 and a second bump 262 is provided in the second recess 261. Therefore, the first dent 165 can be engaged with the first bump 252 and the spring tenon 176 can be engaged with the second bump 262. The terminal board 60 comprises a third end face 18 and a fourth end face 19. At least one recess 181 is inwardly defined below the first end face 16, the second end face 17, the third end face 18 and the fourth end face 19 such that the recess 181 of the terminal board 60 can be fixed to the stair 211 of the rack 21. Therefore, the terminal board 60 can be retained within the frame without using ultrasonic wave fusion.

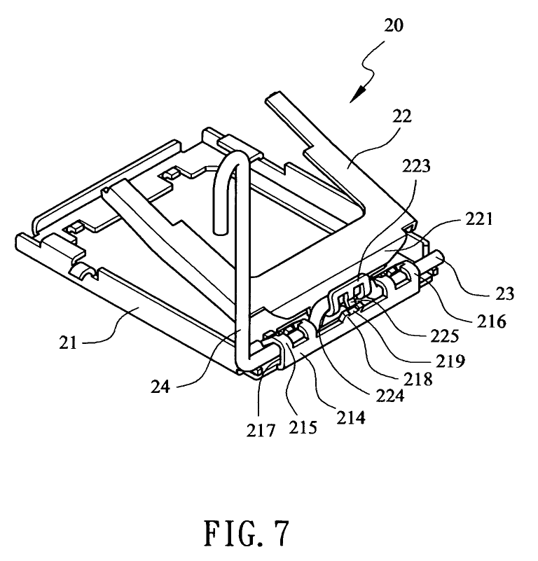

FIG. 7 shows a perspective view of the frame 20 of the CPU connector according to the present invention. The frame 20 in the CPU connector according to the present invention comprises a rack 21 and a cover 22 pivotally connected through a crank 23 to have relative rotation therebetween. The crank 23 comprises a handle 24 at one end thereof and the operation of the handle 24 can rotate the cove 22. The rack 21 comprises an end plate 214 at one end thereof and a first device 215 and a second device 216 are arranged at the end plate 214. The first device 215 and the second device 216 are wrapped to form an axial hole 217 into which the crank 23 is contained and rotatable.

A positioning section 218 is provided between the first device 215 and the second device 216. A third device 223 is arranged at the end plate 221 of the cover 22 and wrapped to form an axial ring 224, which can be capped to the crank 23. A post 225 is formed outward at the third device 223. When the handle 24 is moved to predetermined position, the handle 24 moves the crank 23 to rotate to abut against the positioning section 218. The crank 23 links the cover 22 such that the post 225 is clamped to the recess 219 on the positioning section 218. The end plate 221 of the cover 22 comprises a positioning post 222 beside the third device 223. The positioning post 222 is clamped on the neck of the crank 23. Therefore, the cover 22 and handle 24 of the frame 20 can be clamped simultaneously.

To sum up, the resilience of the first spring section of the terminal provides upward pushing face and preload pressure for the bevel of the protection board. The terminal can scratch dirt from CPU contact face and the unevenness of the motherboard can be compensated by the tin ball to enhance soldering yield. The terminal board can be directly fixed in the frame and ultrasonic fusion is not needed.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A central processing unit (CPU) connector comprising a protection board and a terminal board, the protection board assembled to the terminal board, the protection board comprising a plurality of longitudinal ribs and a plurality of latitude ribs, a through hole defined between the longitudinal rib and a plurality of latitude rib, the terminal board comprising a plurality of terminal holes and each of the terminal holes containing a terminal such that the terminal extending into the through hole, the latitude rib comprises a first face, a second face and a bevel, the terminal comprising a first spring section and an arc section at free end of the first spring section.

2. The CPU connector as in claim 1, wherein the first spring section comprises a slanting line segment.

3. A central processing unit (CPU) connector comprising a terminal board with a plurality of terminal holes, the terminal board comprising a plurality of first ribs and a plurality of second ribs on bottom thereof, each of the terminal holes containing a terminal, the terminal comprising a second spring section and a protection section formed on a free end of the second spring section, a plurality of passageways defined on the second rib and a clamping face formed on wall of the passageway such that a tin ball is clamped by the clamping face and the protection section.

4. The CPU connector as in claim 3, wherein the second rib is formed atop the first rib.

5. The CPU connector as in claim 3, wherein the clamping face is an arced face.

6. The CPU connector as in claim 3, wherein the clamping face is a stair face.

7. The CPU connector as in claim 3, wherein the clamping face is a bevel face.

8. A terminal comprising an attaching section, a first spring section and a second spring section formed on two ends of the attaching section, an arc section formed at free end of the first spring section and a protection section formed on the second spring section.

9. The terminal as in claim 8, wherein the first spring section comprises an arced section connected to the attaching section.

10. The terminal as in claim 9, wherein the arced section is of S shape.

11. The terminal as in claim 8, wherein the second spring section comprises a continuous curve section connected to the attaching section.

12. A central processing unit (CPU) connector comprising:
a terminal board comprising a first end face and a second end face, the first end face comprising a plurality of first lockers and the second end face comprising a plurality of second lockers; and
a frame comprising a rack and a cover pivotally connected through a crank to have relative rotation therebetween, the rack comprising a stair with a first edge and a second edge, the first edge comprising a plurality of third lockers and the second edge comprising a plurality of fourth lockers corresponding to the third lockers, whereby the first lockers can be engaged with the third lockers and the second lockers can be engaged with the fourth lockers.

13. The CPU connector as in claim 12, wherein the first locker is a first dent and the second locker is a second dent, a spring tenon vertically provided at top of the second dent, the third locker being a first recess with a first bump therein, the forth locker being a second recess with a second bump therein, whereby the first dent is engaged with the first bump and the spring tenon is locked to the second bump.

14. The CPU connector as in claim 12, wherein the first locker is a first dent with a spring tenon vertically formed at top of the first dent, the second locker is a second dent with a spring tenon vertically formed at top of the second dent, the third locker being a first recess with a first bump therein, the forth locker being a second recess with a second bump therein, whereby the spring tenon of the first dent is engaged with the first bump and the spring tenon of the second dent is locked to the second bump.

15. The CPU connector as in claim 12, wherein the terminal board comprises a third end face and a fourth end face, at least one recess inwardly defined below the first end face, the second end face, the third end face and the four end face such that the recess can be fixed to the stair of the rack.

16. A central processing unit (CPU) connector comprising a frame with a rack and a cover pivotally connected through a crank to have relative rotation therebetween, a handle being provided at one end of the crank, the rack comprising an end plate with a first device and a second device, an axial hole defined by the first device and the second device and the crank being rotatable in the axial hole, a positioning section between the first device and the second device, a third device arranged at the end plate to form an axial ring such that the axial ring is capped to the crank and the third device comprising a post for clamping the positioning section.

17. The CPU connector as in claim 16, wherein the end plate comprises a positioning post near the third device and the positioning post can be clamped to the first device.
